(19) United States
(12) Patent Application Publication
(10) Pub. No.: US 2016/0034249 A1
(43) Pub. Date: Feb. 4, 2016

(54) SPEECHLESS INTERACTION WITH A SPEECH RECOGNITION DEVICE

(71) Applicant: Microsoft Technology Licensing LLC, Redmond, WA (US)

(72) Inventors: Austin Seungmin Lee, Seattle, WA (US); Oscar E. Murillo, Redmond, WA (US); Yuenkeen Cheong, Sammamish, WA (US); Lorenz Henric Jentz, Seattle, WA (US); Lisa Stifelman, Palo Alto, CA (US); Monika R. Wolf, Seattle, WA (US); Christina Chen, Bellevue, WA (US)

(21) Appl. No.: 14/448,535

(22) Filed: Jul. 31, 2014

(51) Int. Cl. G06F 3/16; G10L 13/04; G06F 3/01; G10L 15/22

(52) U.S. Cl. CPC G06F 3/167; G10L 15/22; G10L 13/043; G06F 3/017; G10L 2015/223

(57) ABSTRACT

Embodiments for interacting with speech input systems are provided. One example provides an electronic device including an earpiece, a speech input system, and a speechless input system. The electronic device further includes instructions executable to present requests to a user via audio outputs, and receive user inputs in response to the requests via a first input mode in which user inputs are made via the speech input system, and also receive user inputs in response to the requests via a second input mode in which responses to the requests are made via the speechless input system.

### BRIEF DESCRIPTION OF THE DRAWINGS

FIG. 1 schematically shows an example personal assistant computing device comprising an earpiece and a host.

FIG. 2 schematically shows an example implementation of the earpiece and host of FIG. 1.

FIG. 3 is a flow chart illustrating an example method of receiving inputs on a computing device.

FIG. 4 illustrates an example organization of speechless inputs into groupings of similar input types.

FIG. 5 schematically shows example speechless inputs.

FIG. 6 shows a block diagram of an example computing system.

### DETAILED DESCRIPTION

Speech input systems may be configured to recognize and process user speech inputs. Speech input systems may be implemented on many different types of computing devices, including but not limited to mobile devices. For example, a computing device may be configured to function as a personal assistant computing device that operates primarily via speech inputs. An example personal assistant computing device may take the form of a wearable device with an earpiece user interface. The earpiece may comprise one or more microphones for receiving speech inputs, and also may comprise a speaker for providing audio outputs, e.g. in the form of synthesized speech. The personal assistant computing device may include instructions executable by a processing system of the device to process speech inputs, perform tasks in response to the speech inputs, and present results of the task. As an example, the personal assistant computing device may present an option via a synthesized speech output (e.g. “would you like a list of nearby restaurants?”), receive a speech input (“yes” or “no”), process the results (e.g. present a query, along with location information (e.g. global positioning system (GPS) information), to a search engine), receive the results, and present the results via the speaker of the earpiece.

In some examples, a computing device may not include a display screen. As such, speech may be a primary mode of interaction with the device. However, in various situations, for examples, when the user is in a public setting or otherwise does not desire to speak, interactions with such a computing device may be difficult to perform with a desired degree of privacy.

Embodiments are disclosed that relate to interacting with speech input systems via non-speech inputs. One example provides an electronic device comprising an earpiece, a speech input system, and a speechless input system. The electronic device further comprises instructions executable to present requests to a user via audio outputs, and receive user inputs in response to the requests via a first input mode in which user inputs are made via the speech input system, and also receive user inputs in response to the requests via a second input mode in which responses to the requests are made via the speechless input system.

Speechless inputs may be implemented for use on a computing device which may utilize speech as a primary input mode. The disclosed embodiments may help to extend the scope of environments in which a personal assistant computing device, or other device that primarily utilizes speech interactions, may be used, as a speechless input mode may allow interactions in settings where privacy concerns may discourage speech interactions.

Speechless inputs may be implemented with a variety of mechanisms, such as by motion sensor(s) (such as inertial motion sensor(s), image sensor(s), touch sensor(s), physical buttons, and other non-speech input modes. Because a speech input-based computing device, such as a personal assistant computing device, may support many different user interactions, a user may have to learn a relatively large number of speechless inputs to interact with the device where each desired control of the personal assistant computing device is mapped to a unique gesture or touch input.

In some implementations, the functionalities of a personal assistant computing device may be distributed between two or more separate devices, such as an earpiece and a host device that communicates with the earpiece. In such a device, the distribution of device functions between the host and earpiece may increase the complexity of speechless interactions with the device because both the host and earpiece may include user input modes.

Thus, to reduce a potential complexity of the speechless input mode, example groupings of functions into a lesser number of speechless inputs are disclosed, wherein the groupings may allow similar functions to be performed via similar inputs. This may help users to learn how to perform speechless interactions more easily. As one non-limiting example, speechless inputs may be grouped by input mode based upon a function being controlled. In such an implementation, software interactions (e.g. interactions with the personal assistant functionality) may be performed via inputs received at the earpiece, and physical hardware interactions (e.g. power on/off, volume control, capacitive touch input, and other hardware input devices) may be performed via inputs at a host device separate from the earpiece. Likewise, physical hardware interactions may be performed on the earpiece and personal assistant interactions on the host in other implementations. In yet other implementations, physical hardware control and personal assistant software interactions may be performed via different input devices (e.g. a touch sensor and a motion sensor) on a same component (e.g. both on host, or both on earpiece). More generally, physical hardware control interactions and personal assistant control may be performed via different input modes. In this way, a distinction may be made between user interactions with the information request and presentation interface and the physical device interface.

To further reduce the number of speechless inputs used to interact with a computing device, speechless inputs made to control the personal assistant may be further grouped into a positive response group and a negative response group. For the positive response group, the same speechless input may be used to make different affirmative responses in different computing device contexts. For example, a same input may invoke the personal assistant, affirm a request presented by the personal assistant functionality, and/or make a request for additional information being made, depending on the context in which the speechless input is made. Likewise, in the negative response group, a speechless input may mute the personal assistant and dismiss a request presented by the personal assistant, again depending upon the context of the device when the input is made. In this way, logical grouping of a number of seemingly different actions and/or user responses may be made by bucketing the inputs into a smaller number of categories, such as physical hardware inputs, positive inputs, and negative inputs.

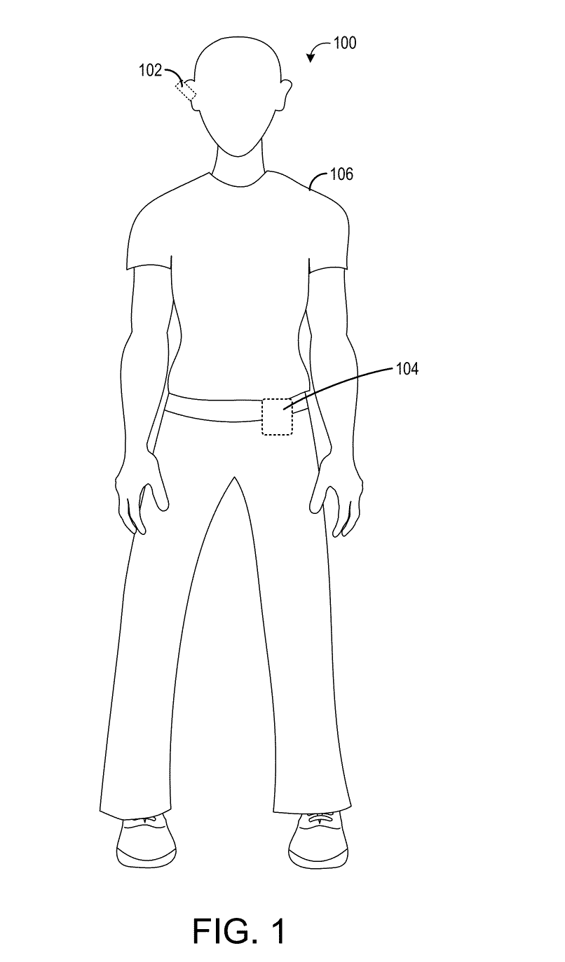

FIG. 1 shows an example personal assistant computing device 100 including an earpiece 102 and a host 104. In alternative examples personal assistant computing device 100 may include a second earpiece in addition to earpiece 102. The second earpiece may include functionally the same as, or different from, earpiece 102. As explained in more detail below, the earpiece 102 may include a plurality of input mechanisms, including a microphone to receive speech inputs and one or more other sensors to receive speechless inputs, such as a motion sensor and/or a touch sensor. The earpiece 102 may also include one or more speakers for outputting audio outputs, including but not limited to, synthesized speech outputs to a user 106. The speaker may be non-occluding to allow ambient sounds and audio from other sources to reach the user's ear. By providing the speech input and output (e.g., the microphone and speakers) in a component configured to reside in the user's ear (e.g., the earpiece), speech inputs made by the user, as well as speech and other audio outputs from the personal assistant computing device, may be presented discreetly without disruption from background noise and while maintaining privacy of the outputs.

The earpiece 102 may be configured to communicate with the host 104 via a suitable wired or wireless communication mechanism. Further, the host 104 may be configured to be worn on the user. For example, the host 104 may be configured to be worn as a necklace, worn on a wrist, clipped to a user's clothing (e.g. a belt, shirt, strap, or collar.), carried in a pocket, briefcase, purse, or other proximate accessory of the user, or worn in any other suitable manner.

The host 104 may include an external network communication system for interfacing with an external network, such as the Internet, to allow the personal assistant functionality to interface with the external network for performing search queries and other tasks. For example, a user may request, via a speech input to the earpiece, to receive a list of all restaurants within a two block radius of the user's current location. The earpiece 102 may detect the speech input and send the request to the host 104. The host 104 may then obtain information (e.g. search results) relevant to the query and send the information to the earpiece 102. A list of the restaurants may then be presented to the user via synthesized speech outputs of the earpiece 102.

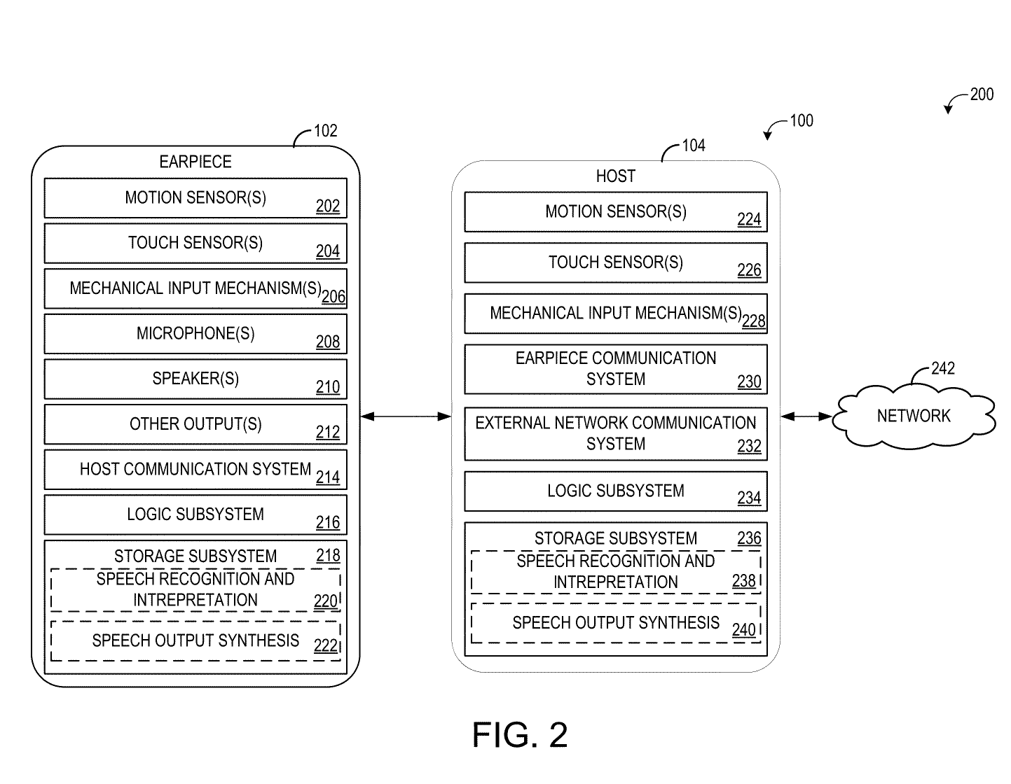

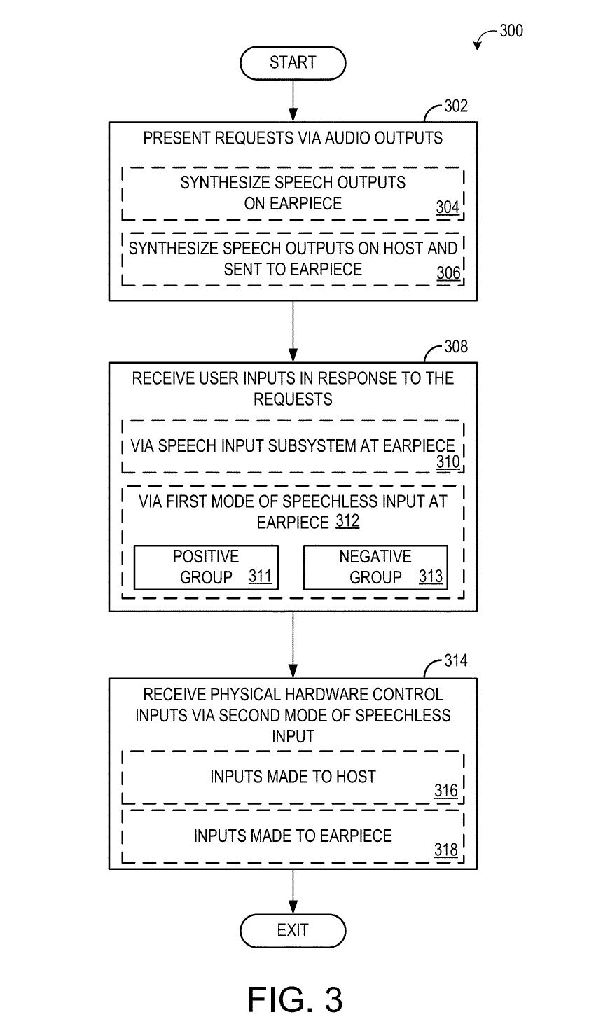

Recognition and/or interpretation of the speech inputs of the user may be performed partially or fully by the earpiece 102, the host 104, and/or a remote computing device in communication with the host and/or earpiece via a network. Similarly, the synthesized speech outputs may be generated by the earpiece 102, host 104, and/or an external computing device, as described below with reference to FIGS. 2 and 3.

As mentioned above, in some settings a user may not wish to interact with the earpiece 102 and host 104 via speech inputs. Thus, the earpiece 102 and/or host 104 may be configured to receive speechless inputs from the user. As one non-limiting example, physical hardware controls, such as device power on/off controls and volume up/down controls, may be made to one or more speechless input mechanisms on the host 104. Examples of speechless input mechanisms on the host 104 may include, but are not limited to, one or more mechanical buttons (such as a scroll wheel, toggle button, paddle switch, or other button or switch), one or more touch sensors, and/or one or more motion sensors. Further, in such an example, personal assistant interactions, such as activating the personal assistant or responding to requests provided by the personal assistant, may be performed via one or more speechless input mechanisms on the earpiece 102. Examples of speechless input mechanisms on the earpiece 102 may include, but are not limited to, one or more motion sensors, touch sensors, and/or mechanical buttons.

It will be understood that the illustrated hardware configuration of FIG. 1 is presented for the purpose of example, and is not intended to be limiting in any manner In other examples, the host may take on any other suitable configuration, such as a wrist-worn device, a necklace, a puck stored in a shoe heel, or a low-profile device stored on a user's body using elastic, hook and loop fastener(s), and/or some other mechanism. In further examples, the host may not be a dedicated personal assistant computing device component that forms a multi-component device with the earpiece, but may instead be an external, independent device, such as a mobile computing device, laptop, or other device, not necessarily configured to be worn by the user. In still further examples, the device may not include a host, and all functionalities may reside in the earpiece.

FIG. 2 shows a block diagram 200 schematically an example configuration of the personal assistant computing device 100, and illustrates example components that may be included on the earpiece 102 and host 104. Earpiece 102 comprises one or more sensors for receiving user input. Such sensors may include, but are not limited to, a motion sensor 202, touch sensor 204, mechanical input mechanism 206, and microphone 208. Any suitable motion sensor(s) may be used, including but not limited to one or more gyroscope(s), accelerometer(s), magnetometer(s), or other sensor that detects motion in one or more axes. Likewise, any suitable touch sensor may be used, including but not limited to capacitive, resistive, and optical touch sensor(s). Examples of suitable mechanical input mechanism(s) 206 may include, but are not limited to, scroll wheel(s), button(s), dial(s), and/or other suitable mechanical input mechanism. The earpiece 102 also includes one or more outputs for presenting information to a user, such as one or more speakers 210 and potentially other output mechanisms 212, such as a haptic output (e.g., vibrational output system).

The earpiece 102 further includes a host communication system 214 configured to enable communicating with the host 104 or other personal assistant computing device component. The host communication system 214 may communicate with the host 104 via any suitable wired or wireless communication protocol.

The earpiece 102 may also include a logic subsystem 216 and a storage subsystem 218. The storage subsystem includes one or more physical devices configured to hold instructions executable by the logic subsystem 216, to implement the methods and processes described herein, for example. Storage subsystem 218 may be volatile memory, non-volatile memory, or a combination of both. Methods and processes implemented in logic subsystem 216 may include speech recognition and interpretation 220 and speech output synthesis 222. The speech recognition and interpretation 220 may include instructions executable by the logic subsystem 216 to recognize speech inputs made by the user as detected by the microphone 208, as well as to interpret the speech inputs into commands and/or requests for information. The speech output synthesis 222 may include instructions executable by the logic subsystem 216 to generate synthesized speech outputs from information received from the host 104, for example, to be presented to the user via the one or more speakers 210. Storage subsystem 218 also may include instructions executable by the logic subsystem 216 to receive signals from the motion sensor 202, touch sensor 204, and/or mechanical input mechanism 206 and interpret the signals as commands for controlling the information retrieval and/or speech output synthesis.

As mentioned above, in various different implementations, these functions may be distributed differently between the host and the earpiece. For example, speech recognition and interpretation, and/or speech output synthesis functions also may be performed on the host, or distributed between the host and earpiece. The term “speech input system” may be used herein to describe components (hardware, firmware, and/or software) that may be used to receive and interpret speech inputs. Such components may include, for example, microphone 208 to receive speech inputs, and also speech recognition and interpretation instructions 220. Such instructions also may reside remotely from the earpiece (e.g., on the host, as described in more detail below), and the speech input system may send the signals from the microphone (in raw or processed format) in order for the speech recognition and interpretation to be performed remotely.

The term “speechless input system” may be used herein to describe components (hardware, firmware, and/or software) that may be used to receive and interpret speechless inputs. A speechless input system may include, for example, one or more of motion sensor(s) 202, touch sensor(s) 204, and mechanical input mechanism(s) 206, and also instructions executable to interpret user input signals from these sensors as commands for controlling the information retrieval from the host and/or the output of the synthesized speech. As mentioned above, these components may be located on the earpiece, the host (as described in more detail below), or distributed between the earpiece and host in various implementations.

The term “synthesized speech output system” may be used herein to describe components (hardware, firmware, and/or software) that may be used to provide speech outputs via an audio output system. A synthesized speech output system may include for example, speech output synthesis instructions 222 and speaker(s) 210. The speech output synthesis instructions also may be located at least partially on host 104, as described in more detail below.

The host 104 also includes one or more input mechanisms for receiving user inputs. For example, the host may include one or more motion sensor(s) 224, touch sensor(s) 226, and mechanical input mechanism(s) 228, such as those described above for the earpiece. The host 104 also includes an earpiece communication system 230 for communicating the with the earpiece 102, and an external network communication system 232 for communicating with an external network 242 (e.g. a computer network, mobile phone network, and/or other suitable external network).

The host 104 may also include a logic subsystem 234 and a storage subsystem 236. The storage subsystem 236 includes one or more physical devices configured to hold instructions executable by the logic subsystem 234 to implement the methods and processes described herein, for example. Such instructions may include speech recognition and interpretation instructions 238 and speech output synthesis instructions 240. As described above, these functionalities also may reside on the earpiece 102, or be distributed between the earpiece 102 and host 104.

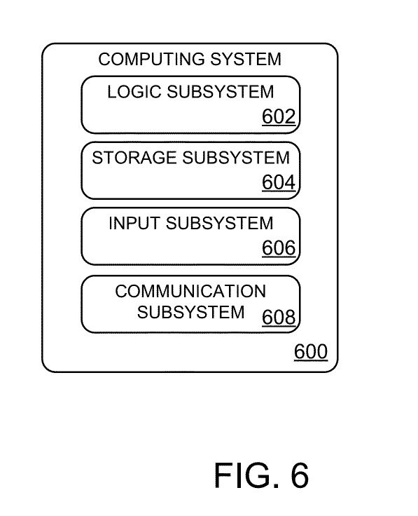

Storage subsystem 236 also may include instructions executable by the logic subsystem 234 to receive signals from the motion sensor 224, touch sensor 226, and/or mechanical input mechanism 228 and interpret the signals as commands for controlling personal assistant computing device power, volume control, or other physical hardware functions. Additional details regarding logic subsystem and storage subsystem configurations are described below with regard to FIG. 6.

The personal assistant computing device 100 further may include an information request and retrieval system, which may be referred to as a personal assistant. The personal assistant may comprise instructions executable to receive requests for information (e.g. as speech inputs, as algorithmically generated requests (e.g. based upon geographic location, time, received messages, or any other suitable trigger), and/or in response in any other suitable manner), send the requests for information to an external network, receive the requested information from the external network, and send the information to the synthesized speech output system. The instructions executable to operate the personal assistant may be located on the earpiece 102, the host 104, or distributed between the devices. Some instructions of the personal assistant also may reside on one or more remote computing devices accessed via a computer network. The personal assistant may also include instructions to present information to the user, such as requests for further information, clarifications, interaction initiations, or other commands or queries.

FIG. 3 shows a flow diagram illustrating an embodiment of a method 300 for managing inputs on a personal assistant computing device. Method 300 may be performed on the personal assistant computing device 100 described above with respect to FIGS. 1 and 2, according to instructions stored on the earpiece and/or host, or on any other suitable device or combination of devices. Method 300 comprises, at 302, presenting requests via an audio output. The requests may be presented in any suitable manner, such as by synthesized speech outputs presented via a microphone on the earpiece. The requests may include any suitable query, such as a request for confirmation of information that has been presented. The synthesized speech outputs may be produced on the earpiece, as indicated at 304, or on the host and then sent to the earpiece for presentation, as indicated at 306.

At 308, method 300 includes receiving user inputs in response to the requests. Various user inputs may be received, such as an affirmation or dismissal of a question posed by the request. In some settings, a user may provide user inputs to a speech input system, as indicated at 310. However, in other settings, such as when the user is interacting with the personal assistant computing device in a non-private setting, the user may wish to avoid communicating with the personal assistant computing device via speech. In these circumstances, the inputs in response to the requests may be made via a first speechless input mode at the earpiece, as indicated at 312. The speechless input at the earpiece may include speechless input detected by one or more speechless input mechanisms, such as a motion sensor, touch sensor, and/or mechanical input mechanism. The speechless input may be processed at the earpiece, or sent to a host device for processing.

As mentioned above, speechless inputs made via the first mode of speechless inputs may be categorized into a positive response group 311 and a negative response group 313, with a different gesture and/or touch input mapped to each group. Various different inputs may be grouped in each of these groups. For example, as requests presented to the user by the personal assistant computing device at 302 may be answered via a simple yes or no response, a “yes” response may be included in the positive response group, and a “no” response in the negative response group. In some contexts, a user may be able to request additional information as a response to a personal assistant request (a “tell me more” input). Such an input may be grouped with the positive responses. Further, a user input requesting to activate the personal assistant (an “invocation”) may be grouped with the positive responses. Likewise, muting of the personal assistant (a “do not bother me” input) may be grouped with the negative responses, along with a “no” response.

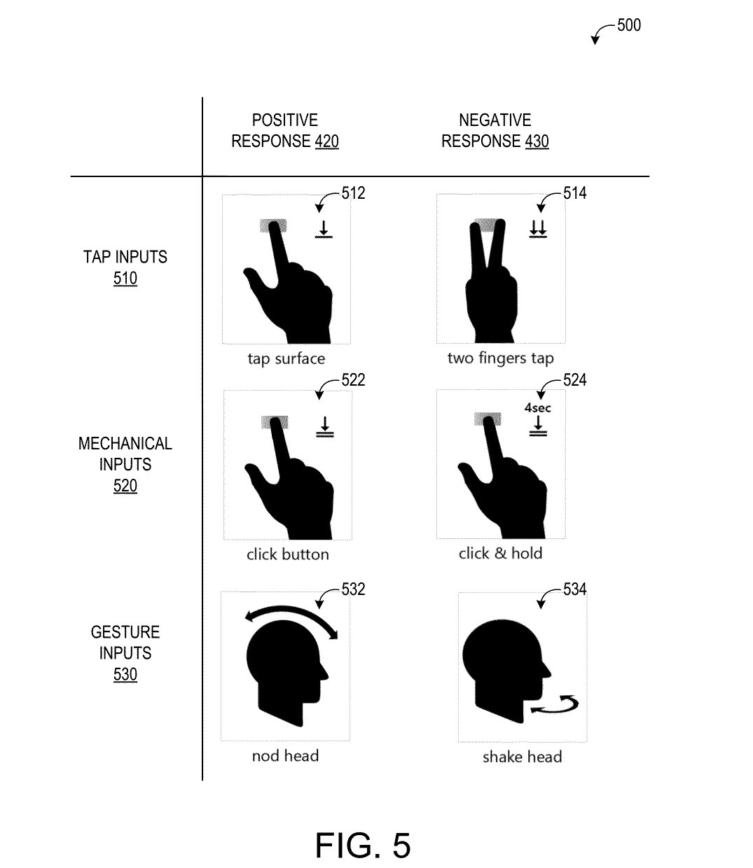

In some implementations, each response in positive response group may be indicated by a common input, such as a head nod or a single tap on the earpiece (as detected via a motion sensor and/or touch sensor), as examples. Similarly, each response in the negative response group may be indicated by a different common input, such as shaking the head back and forth or by tapping the earpiece two times, as non-limiting examples. Other illustrative touch and gesture inputs for the positive and negative response groups are described below with respect to FIG. 5.

As the positive and negative response groups each may utilize a common input (that differs between the groups), the specific command that a user intends to make may be differentiated from other commands sharing the same common input based on the context of the request that precipitated the response. For example, if the request presented by the personal assistant included the query “would you like me to find more restaurants in your area?,” a positive response input would be interpreted as a “yes” response, in light of the context of the question. In another example, if a positive response input is provided without a preceding request from the personal assistant, the response input may be interpreted as an invocation to activate the personal assistant. In a further example, if the user entered a negative response input to the query for additional restaurants discussed above, the personal assistant may interpret the negative response as a no, rather than a mute. To mute the personal assistant in such a circumstance, the negative response input may be entered a second time, for example.

Continuing with FIG. 3, as mentioned above, physical hardware interactions may be considered an additional group of inputs than the positive and negative input groups for speech system interactions. As such, method 300 comprises, at 314, receiving physical hardware control inputs via a second speechless input mode. The second mode of speechless input is differentiated from the first mode in that the second mode controls hardware functionality of the device, such as power on/off or volume up/down, whereas the first mode controls the personal assistant functionality, such as responding to the requests provided by the personal assistant. In some implementations, the inputs made via the second mode of speechless input may be made to the host, as indicated at 316. As such, the host may include one or more input mechanisms, such as buttons or touch sensors, with which a user may make inputs in order to power on or off the personal assistant computing device (including the earpiece) or adjust the volume of audio outputs provided by the earpiece.

In other examples, the inputs of the second mode of speechless inputs may be made to the earpiece, as indicated at 318. In these examples, the second mode of speechless inputs may utilize a different input sensor than the first mode of speechless inputs. As an illustrative example, the first mode of speechless inputs may utilize a motion sensor for positive and negative interactions with the personal assistant, whereas a second mode of speechless inputs may utilize a touch sensor or mechanical input for physical hardware control.

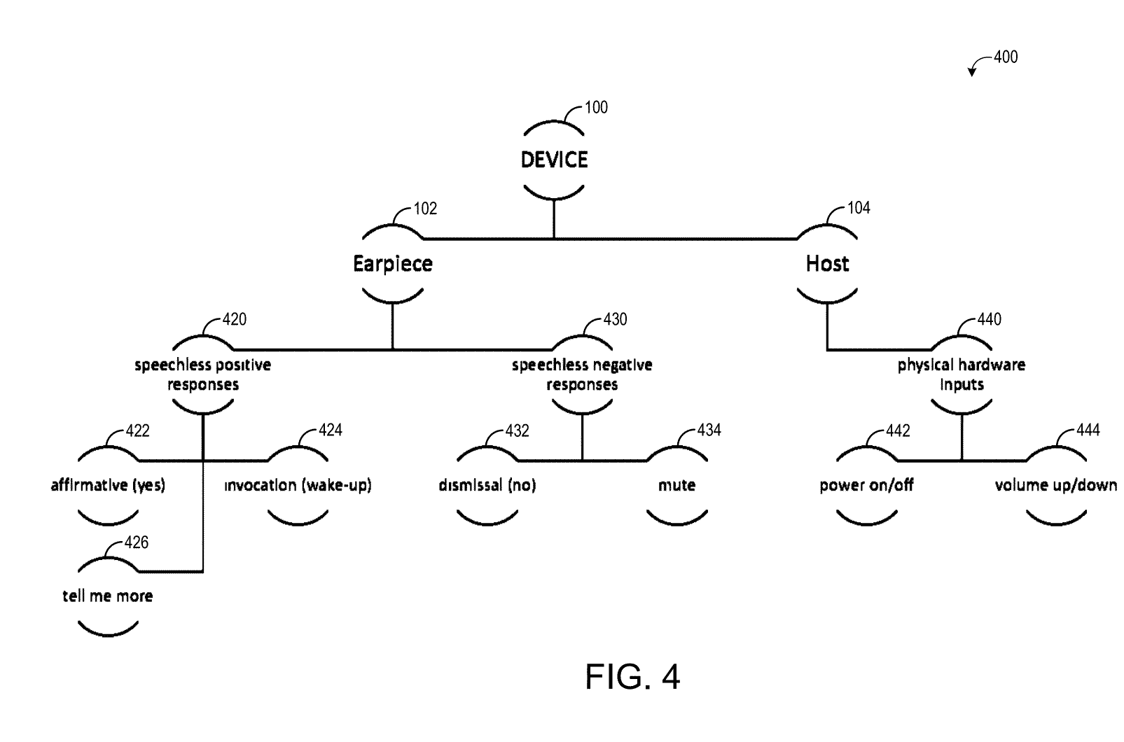

FIG. 4 shows a schematic diagram 400 illustrating an organization of personal assistant computing device controls, and illustrates inputs that may be made at the host and at the earpiece according to a non-limiting example. The inputs made to the personal assistant computing device may be broken down into three categories of inputs: speechless positive responses 420 made at the earpiece, speechless negative responses 430 also made at the earpiece, and physical hardware inputs 440 made at the host.

The speechless positive responses 420 include affirmative responses 422 (e.g., yes), invocations 424, and tell me more responses 426. The speechless negative responses 430 include dismissal responses 432 (e.g., no) and mute 434. The physical hardware inputs include power on/off 442 and volume up/down 444. Such an organization may allow a relatively larger number of interactions to be performed via a relatively smaller number of user inputs grouped into logical groups. This organization may advantageously provide the user with a more accessible, intuitive user experience because the user may associate input groups with either the earpiece or the host along the lines of the organization depicted in schematic diagram 400. This organization may also simplify the hardware and software resources devoted to handling these various inputs because the organization may load the earpiece with certain input responsibilities while offloading other input responsibilities to the host.

FIG. 5 shows a diagram 500 illustrating non-limiting examples of how the inputs of the positive and negative groupings of FIG. 4 may be made. In some implementations speechless inputs may be made via tap inputs (e.g., touch inputs), as shown at 510. In this example, positive inputs may be performed via a first touch input 512, e.g. by tapping the surface of the earpiece with one finger. In some examples, the input may include tapping any surface of the earpiece (e.g. for detection via a motion sensor), while in other examples the input may include tapping a specific location of the earpiece (e.g. on a touch sensor). Likewise, in this example, negative inputs may be performed via a second touch input 514, e.g. by tapping the surface of the earpiece with two fingers.

In some implementations, speechless inputs also may be performed via mechanical inputs 520. In this example, positive inputs may be performed via a first mechanical input 522, for example, by clicking a button and holding the button in the pressed state for less than a threshold amount of time. A second mechanical input 524 to indicate a negative input may be performed clicking the button and holding for a threshold amount of time, such as four or more seconds as a non-limiting example.

Further, in some implementations, speechless inputs may be performed via head gesture. In this example, positive inputs may be performed by a first gesture input 532, for example by nodding a head in an up and down manner as detected via a motion sensor. A second gesture input 534 to indicate a negative input may include shaking a head in a back and forth manner.

It is to be understood that the above example inputs are provided for example only and are not limiting, as other inputs are possible. For example, a negative group touch input may include tapping the surface of the earpiece two times. In another example, a negative group mechanical input may include clicking a button two times. Virtually any touch, mechanical, or gesture input is within the scope of this disclosure.

Thus, the systems and methods described above provide for a first example of an electronic device comprising an earpiece, a speech input system, a speechless input system, and instructions executable to present requests to a user via audio outputs, and receive user inputs in response to the requests via a first input mode in which user inputs are made via the speech input system, and also receive user inputs in response to the requests via a second input mode in which responses to the requests are made via the speechless input system.

The speechless input system may comprises one or more of a touch input sensor, mechanical button, and motion sensor. The speechless input system may comprise two or more of a touch input sensor, mechanical button, and motion sensor, and the instructions may be executable to receive physical hardware interactions via a first speechless mode and personal assistant interactions via a second speechless mode.

The earpiece may be configured to communicate wirelessly with an external host. In an example, the external host and earpiece form two separate parts of a multi-part device with distributed functionality, and the speechless input system may comprise one or more of a touch input sensor, mechanical button, and motion sensor located on the external host, and one or more of a touch input sensor, mechanical button, and motion sensor located on the earpiece. The one or of the touch input sensor, mechanical button, and motion sensor on the external host may be configured to receive physical hardware inputs, and the one or more of the touch input sensor, mechanical button, and motion sensor on the earpiece may be configured to receive personal assistant inputs. The physical hardware inputs may control one or more of device volume output and power status, and the personal assistant inputs may comprise a positive interaction group and a negative interaction group.

In another example, the external host device is independent from the earpiece, and the earpiece is configured to communicate with an external network through the external host device. The earpiece may be configured to receive earpiece physical hardware inputs and personal assistant inputs. One or more sensors on the independent external host device may be configured to receive earpiece physical hardware inputs.

In another example, an earpiece configured to communicate with an external device and with a wide area computer network through the external device comprises a speech input system configured to receive speech inputs, a synthesized speech output system configured to output synthesized speech outputs via the earpiece, and a speechless input system comprising two or more modes of receiving non-speech user inputs. The earpiece also includes instructions executable to present requests via the synthesized speech output system, receive responses to the requests optionally via the speech input system and via a first mode of the speechless input system, and receive physical hardware control inputs via a second mode of the speechless input subsystem.

In an example, the first mode of the speechless input system may include a first sensor on the earpiece, and the second mode of the speechless input system may include a second sensor on the earpiece. In another example, the first mode of the speechless input system may include a first sensor on the earpiece, and the second mode of the speechless input system may comprise instructions executable to receive speechless inputs made via the external device. In a further example, the first mode of the speechless input may include a motion sensor, and the instructions may be executable to identify a first gesture input and a second gesture input via feedback from the motion sensor, the first gesture input comprising an affirmative response to the requests and the second gesture input comprising a negative response to the requests.

In yet another example, a multi-component device comprises a host and an earpiece. The host comprises an earpiece communications system, a communications system configured to communicate over a wide area network, a host user input system comprising one or more speechless input modes, and a host storage subsystem holding instructions executable by a host logic subsystem. The earpiece comprises a host communications system, a synthesized speech output system, an earpiece input system comprising one or more speechless input sensors, and an earpiece storage subsystem holding instructions executable by an earpiece logic subsystem. The instructions on the host and the earpiece are executable to receive physical hardware control inputs at the host input system, and receive speechless inputs for interacting with a personal assistant.

The host user input system may comprise one or more of a touch input sensor, mechanical button, and motion sensor. The hardware control inputs at the host user input system may control device audio volume output and power status. The speechless inputs for interacting with personal assistant may include touch inputs identified via feedback from a touch sensor of the earpiece input system. The speechless inputs for interacting with the personal assistant may include gesture inputs identified via feedback from a motion sensor of the earpiece input subsystem.

The speechless inputs for interacting with the personal assistant may include an affirmative response input group comprising one or more of an activation of the earpiece request, affirmation of a request presented via the synthesized speech output subsystem, and an additional information request in response to the request presented via the synthesized speech output subsystem.

The speechless inputs for interacting with the personal assistant may include a negative response input group comprising one or more of a deactivation request of at least the synthesized speech output system and a dismissal of a request presented via the synthesized speech output subsystem.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 may be one non-limiting example of earpiece 102 and/or host 104, and/or an external device that interfaces with earpiece 102 and/or host 104. Computing system 600 is shown in simplified form. Computing system 600 also may take the form of one or more personal computers, server computers, tablet computers, home-entertainment computers, network computing devices, gaming devices, mobile computing devices, mobile communication devices (e.g., smart phone), objects having embedded computing systems (e.g., appliances, healthcare objects, clothing and other wearable objects, infrastructure, transportation objects, etc., which may be collectively referred to as the Internet of Things), and/or other computing devices.

Computing system 600 includes a logic subsystem 602 and a storage subsystem 604. Computing system 600 may optionally include an input subsystem 606, communication subsystem 608, and/or other components not shown in FIG. 6.

Logic subsystem 602 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic machines configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 604 includes one or more physical devices configured to hold instructions executable by the logic subsystem to implement the methods and processes described herein. When such methods and processes are implemented, the state of storage subsystem 604 may be transformed—e.g., to hold different data.

Storage subsystem 604 may include removable and/or built-in devices. Storage subsystem 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 604 may include volatile, nonvolatile, dynamic, static, read/write, read-only, random-access, sequential-access, location-addressable, file-addressable, and/or content-addressable devices.

It will be appreciated that storage subsystem 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 602 and storage subsystem 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Input subsystem 606 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Communication subsystem 608 may be configured to communicatively couple computing system 600 with one or more other computing devices. Communication subsystem 608 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and sub-combinations of the various processes, systems and configurations, and other features, functions, acts, and/or properties disclosed herein, as well as any and all equivalents thereof.

1. An electronic device comprising:
an earpiece;
a speech input system;
a speechless input system; and
a memory storing instructions executable to
present requests to a user via audio output, and
receive user inputs in response to the requests via a first input mode in which user inputs are made via the speech input system, and also receive user inputs in response to the requests via a second input mode in which responses to the requests are made via the speechless input system.

2. The electronic device of claim 1, wherein the speechless input system comprises one or more of a touch input sensor, mechanical button, and motion sensor.

3. The electronic device of claim 1, wherein the speechless input system comprises two or more of a touch input sensor, mechanical button, and motion sensor, and wherein the instructions are executable to receive physical hardware interactions via a first speechless mode and personal assistant interactions via a second speechless mode.

4. The electronic device of claim 1, wherein the earpiece is configured to communicate wirelessly with an external host.

5. The electronic device of claim 4, wherein the external host and earpiece form two separate parts of a multi-part device with distributed functionality, and wherein the speechless input system comprises one or more of a touch input sensor, mechanical button, and motion sensor located on the external host, and one or more of a touch input sensor, mechanical button, and motion sensor located on the earpiece.

6. The electronic device of claim 5, wherein the one or of the touch input sensor, mechanical button, and motion sensor on the external host are configured to receive physical hardware inputs, and the one or more of the touch input sensor, mechanical button, and motion sensor on the earpiece are configured to receive personal assistant inputs.

7. The electronic device of claim 6, wherein the physical hardware inputs control one or more of device volume output and power status, and wherein the personal assistant inputs comprise a positive response group and a negative response group.

8. The electronic device of claim 4, wherein the external host device is independent from the earpiece, and wherein the earpiece is configured to communicate with an external network through the external host device.

9. The electronic device of claim 8, wherein the earpiece is configured to receive earpiece physical hardware inputs and personal assistant inputs.

10. The electronic device of claim 8, wherein one or more sensors on the independent external host device are configured to receive earpiece physical hardware inputs.

11. An earpiece configured to communicate with an external device and with a wide area computer network through the external device, the earpiece comprising:
a speech input system configured to receive speech inputs;
a synthesized speech output system configured to output synthesized speech outputs via the earpiece;
a speechless input system comprising two or more modes of receiving non-speech user inputs; and
instructions executable to
present requests via the synthesized speech output system,
receive responses to the requests optionally via the speech input system and via a first mode of the speechless input system, and
receive physical hardware control inputs via a second mode of the speechless input subsystem.

12. The earpiece of claim 11, wherein the first mode of the speechless input system includes a first sensor on the earpiece, and wherein the second mode of the speechless input system includes a second sensor on the earpiece.

13. The earpiece of claim 11, wherein the first mode of the speechless input system includes a first sensor on the earpiece, and wherein the second mode of the speechless input system comprises instructions executable to receive speechless inputs made via the external device.

14. The earpiece of claim 11, wherein the first mode of the speechless input includes a motion sensor, and wherein the instructions are executable to identify a first gesture input and a second gesture input via feedback from the motion sensor, the first gesture input comprising an affirmative response to the requests and the second gesture input comprising a negative response to the requests.

15. A multi-component device, comprising:
a host comprising an earpiece communications system, a communications system configured to communicate over a wide area network, a host user input system comprising one or more speechless input modes, and a host storage subsystem holding instructions executable by a host logic subsystem; and
an earpiece comprising a host communications system, a synthesized speech output system, an earpiece input system comprising one or more speechless input sensors, and an earpiece storage subsystem holding instructions executable by an earpiece logic subsystem, wherein
the instructions on the host and the earpiece are executable to receive physical hardware control inputs at the host input system, and receive speechless inputs for interacting with a personal assistant at the earpiece.

16. The multi-component device of claim 15, wherein the host user input system comprises one or more of a touch input sensor, mechanical button, and motion sensor, and wherein the hardware control inputs at the host user input system control device audio volume output and power status.

17. The multi-component device of claim 15, wherein the speechless inputs for interacting with the personal assistant include inputs received at one or more of a touch sensor and a mechanical button of the earpiece input system.

18. The multi-component device of claim 15, wherein the speechless inputs for interacting with the personal assistant include gesture inputs identified via feedback from a motion sensor of the earpiece input system.

19. The multi-component device of claim 15, wherein the speechless inputs for interacting with the personal assistant include an affirmative response input group comprising one or more of an invocation of the personal assistant, affirmation of a request presented via the synthesized speech output subsystem, and an additional information request in response to the request presented via the synthesized speech output subsystem.

20. The multi-component device of claim 15, wherein the speechless inputs for interacting with the personal assistant include a negative response input group comprising one or more of a deactivation request of at least the synthesized speech output system and a dismissal of a request presented via the synthesized speech output subsystem.
